(19) United States
(12) Patent Application Publication
(10) Pub. No.: US 2015/0199201 A1
(43) Pub. Date: Jul. 16, 2015

(54) MEMORY SYSTEM OPERATING METHOD PROVIDING HARDWARE INITIALIZATION

(71) Applicant: SAMSUNG ELECTRONICS CO., LTD., Suwon-Si (KR)

(72) Inventors: SUN-YOUNG LIM, HWASEONG-SI (KR); MIN-YEAB CHOO, SUWON-SI (KR); MI-KYOUNG PARK, SEOUL (KR); DONG-YANG LEE, YONGIN-SI (KR); BU-IL JUNG, HWASEONG-SI (KR); JU-YUN JUNG, HWASEONG-SI (KR); HYUK HAN, SEOUL (KR)

(21) Appl. No.: 14/524,231

(22) Filed: Oct. 27, 2014

(30) Foreign Application Priority Data
Jan. 15, 2014 (KR) 10-2014-0005020

(51) Int. Cl. G06F 9/44

(52) U.S. Cl. CPC G06F 9/4411

(57) ABSTRACT

In a method of operating a memory system including a memory device, a memory controller and a host according to example embodiments, a hardware is initialized based on a fail information and a boot code stored in a nonvolatile memory of a volatile memory and the nonvolatile memory included in the memory device. A host processes data in an internal memory included in the memory controller and a safe region included in the memory device based on the fail information. Using the fail information, the method of operating the memory system according to example embodiments increases the performance of the whole system including the memory system.

### CROSS-REFERENCE TO RELATED APPLICATION

This application claims priority under 35 USC §119 to Korean Patent Application No. 10-2014-0005020 filed on Jan. 15, 2014, the subject matter of which is hereby incorporated by reference.

### BACKGROUND

Embodiments of the inventive concept relate generally to memory systems, methods of operating a memory system, and methods of initializing a memory system.

The manufacture of contemporary semiconductor chips is a highly complex endeavor, and it is well appreciated that during the multiplicity of manufacturing processes applied during the manufacture of semiconductor chips including a memory cell array one or more “bad” memory cells may be produced among the many memory cells in the memory cell array. A “bad memory cell” is one incapable of reliably receiving, storing and/or providing data during (e.g.,) read/write operations over a prescribed set of conditions. Like all memory cells in a memory cell array, each bad memory cell may be identified by a unique address. An address associated with one or more bad memory cells (or a group of memory cells including one or more bad memory cells) may be termed a “fail address”.

Contemporary memory systems use a variety of approaches to essentially block access (e.g., reading and/or writing) to a fail address, so that errant data is not generated.

### SUMMARY

Certain embodiments of the inventive concept provide memory system operating methods capable of increasing memory system performance by using fail information identifying addresses associated with failed memory cell in a nonvolatile memory. Some embodiments of the inventive concept provide methods of initializing a memory system using this type of fail information.

In one aspect, the inventive concept provides a method of operating a memory system including a host, a memory controller including an internal memory, and a memory device, wherein the memory device includes a nonvolatile memory and a volatile memory having a safe region and a fail region. The method comprises; initializing hardware resources based on fail information and boot code stored in the nonvolatile memory, and thereafter, storing write data provided by the host in only the safe region of the memory device, wherein the fail information is used by the memory controller to differentiate between the fail region and safe region of the memory device.

In another aspect, the inventive concept provides a method of operating a memory system including a host, a memory controller including an internal memory, and a memory device, wherein the memory device includes a nonvolatile memory and a volatile memory having a safe region and a fail region. The method comprises; loading a portion of boot code stored from the nonvolatile memory to the internal memory, wherein a data storage capacity of the internal memory is less than a size of the boot code, loading residual boot code from the nonvolatile memory to only the safe region of the volatile memory, wherein the fail information is used by the memory controller to differentiate between the fail region and safe region of the memory device during the storing of the residual boot code, and initializing hardware resources by executing the boot code using at least one of the host and the memory controller.

In another aspect, the inventive concept provides a method of operating a memory system including a host, a memory controller including an internal memory, and a memory device, wherein the memory device includes a nonvolatile memory and a volatile memory having a safe region and a fail region. The method comprises; storing fail information in the nonvolatile memory that identifies addresses corresponding to failed memory cells in a memory cell array of the volatile memory, designating the fail region from the safe region of the volatile memory using the fail information, upon receiving a power supply voltage, loading boot code stored in the nonvolatile memory to one of the internal memory and the safe region, and initializing hardware resources by executing the boot code using at least one of the host and the memory controller.

### BRIEF DESCRIPTION OF THE DRAWINGS

Illustrative embodiments of the inventive concept will be more clearly understood from the following detailed description taken in conjunction with the accompanying drawings.

FIG. 1 is a flowchart illustrating a method of operating a memory system according to certain embodiments of the inventive concept.

FIG. 2 is a block diagram illustrating the memory system according to certain embodiments of the inventive concept.

FIG. 3 is a flow chart further illustrating the step of initialization hardware in the method of FIG. 1.

FIG. 4 is a conceptual diagram illustrating one example of a nonvolatile memory storing boot code and a fail information according to the memory system of FIG. 2.

FIG. 5 is a block diagram illustrating an electronic system including one or more memory systems like the one shown in FIG. 2.

FIGS. 6, 8, 9, 10, 11 and 14 are respective block diagrams further illustrating various aspects of the method of initializing hardware described in relation to FIGS. 1 and 3.

FIG. 7 is a conceptual diagram illustrating address mapping as part of the initializing of pre-boot hardware in the example of FIG. 6.

FIGS. 12 and 13 are respective conceptual diagrams illustrating examples of use of the volatile memory in the memory system of FIG. 2.

FIG. 15 is a conceptual diagram illustrating another example of mapping a logical address of data to a physical address in relation to operation of the memory system of FIG. 2.

FIGS. 16 and 17 are tables showing various aspects address mapping tables that may be used in conjunction with the memory system of FIG. 2.

FIG. 18 is a flowchart summarizing in another example a method of initializing hardware resources in a memory system according to embodiments of the inventive concept.

FIG. 19 is a block diagram illustrating a mobile device including the memory system according to embodiments of the inventive concept.

FIG. 20 is a block diagram illustrating a computing system including the memory system according to embodiments of the inventive concept.

### DETAILED DESCRIPTION

Embodiments of the inventive concept will now be described in some additional detail with reference to the accompanying drawings. The inventive concept may, however, be embodied in many different forms and should not be construed as being limited to only the illustrated embodiments. Rather, these embodiments are provided so that this disclosure will be thorough and complete, and will fully convey the scope of the inventive concept to those skilled in the art. Throughout the written description and drawings, like reference numbers and labels are used to denote like or similar elements.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts identified in flowchart blocks may occur out of the specific order shown in the flowcharts. For example, two blocks shown in succession may in fact be executed substantially concurrently or the blocks may sometimes be executed in the reverse order, depending upon the functionality/acts involved.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Figure (FIG.) 1 is a flow chart illustrating a memory system operating method according to embodiments of the inventive. FIG. 2 is a block diagram illustrating a memory system according to certain embodiments of the inventive concept.

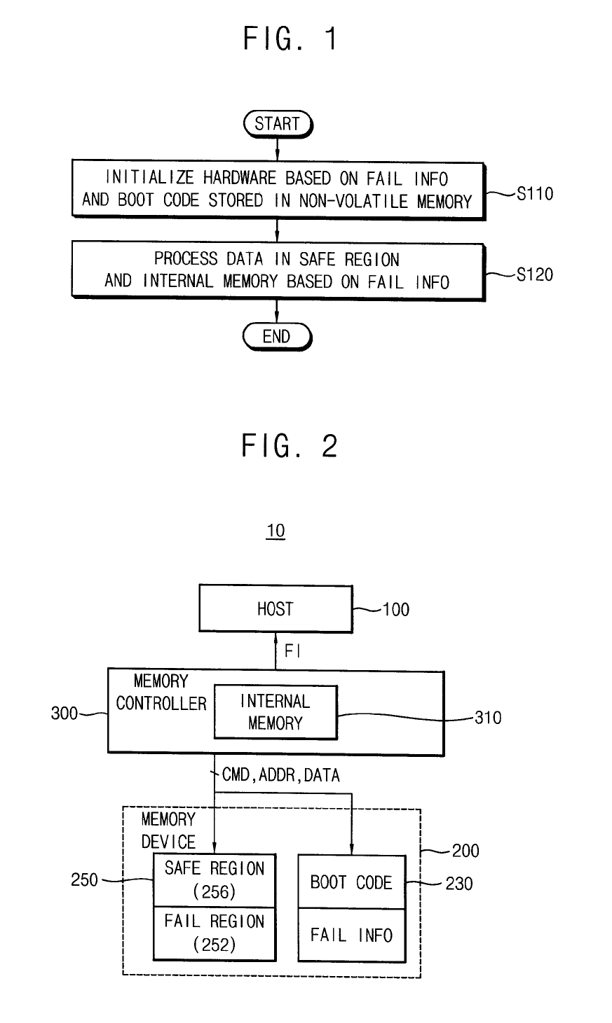

Referring to FIGS. 1 and 2, a memory system 10 comprises; a host 100, a memory controller 300 and a memory device 200.

The memory controller 300 comprises an internal memory 310.

When a power supply voltage is applied to the memory system 10, a power-up sequence is performed in order to initialize the constituent hardware resources in preparation for normal operations. The power-up sequence will usually be defined, at least in part, by “boot code” stored somewhere in the memory system 10. According to embodiments of the inventive concept, certain hardware resources of the memory system 10 may be powered-up (or “initialized”) in relation to (or “based on”) fail information (FI) as well as boot code stored (e.g.,) in a nonvolatile memory 230 of the memory device 200 (S110).

The illustrated example of FIG. 2 assumes that the memory device 200 comprises both a volatile memory 250 and the nonvolatile memory 230. These different portions of the memory device 200 may be variously implemented using, for example, a nonvolatile memory cell array and a separately access volatile memory cell array. The boot code and the fail information are stored in the nonvolatile memory 230, while the volatile memory 250 may be configured to include a safe region 256 and a separate fail region 252.

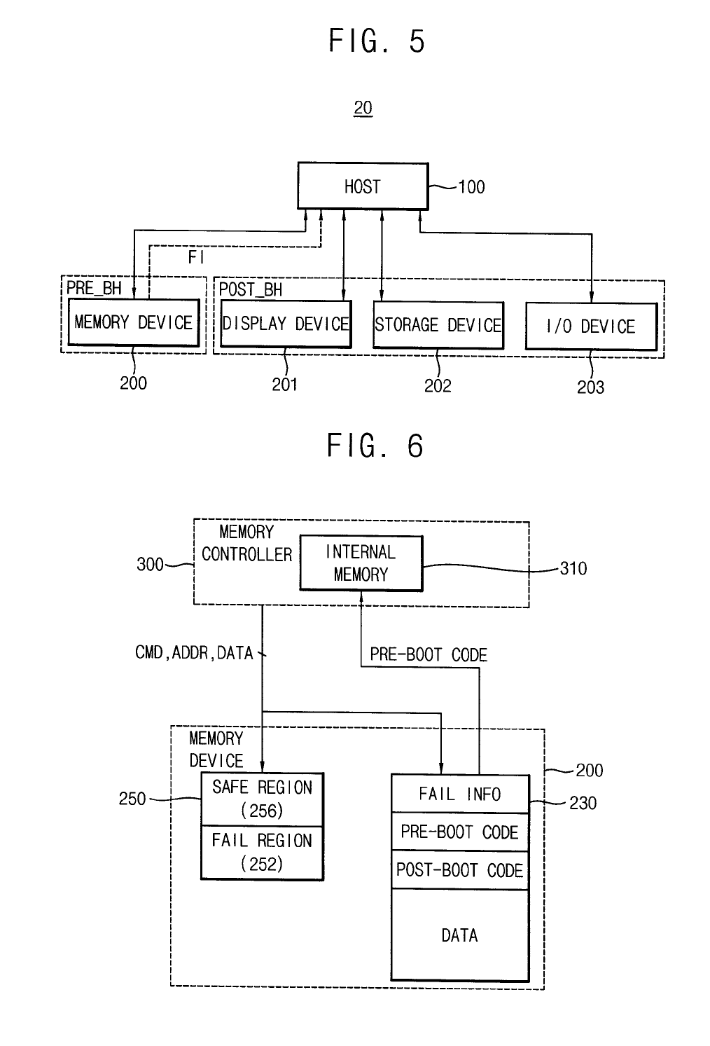

As will be described in some additional detail with respect to FIG. 5, the hardware resources included in the memory system 10 may also include (e.g.,) a display device 201, a storage device 202 and an input/output (I/O) device 203.

When a power supply voltage is applied to memory system 10, the memory device 200 is initialized using the boot code stored in the nonvolatile memory 230. Thus, execution of the boot code (a portion of the boot code) in response to application of the power supply voltage to the memory system 10 in order to initialize at least the memory device 200 may be termed a “first stage” of the initialization routine. Here, the boot code is stored in the nonvolatile memory 230 in order to maintain data integrity during periods when the power supply voltage is not applied to the memory system 10.

The fail information includes at least information identifying fail addresses for one or more memory cell arrays included in the memory device 200. The fail information is also stored in the nonvolatile memory 230 to maintain its integrity during power-off periods for the memory system 10.

It is further assumed that when the memory controller 300 causes “write data” to be written in the safe region 256 of the volatile memory 250, such write data will not be errant, according to the definition of “errant data” established in relation to the memory system 10. For example, in certain embodiments, write data or read data including a single bit error might be considered errant data, while in other embodiments write data or read data including one or more (up to a material number) bit errors may still be considered not-errant data. However defined, stored data required to be non-errant data should be stored in only “safe” memory cells, such as those provided by the safe region 256. Subsequently, when the memory controller 300 reads such safe data from the safe region 256, the data will not include a material number of bit errors.

In contrast, data stored by the memory controller 300 in the fail region 252 of the volatile memory 250 may include a material number of bit errors. Subsequently, when the memory controller 300 reads this data from the fail region 252 it must be considered potentially errant data.

The nonvolatile memory 230 and volatile memory 250 may be accessed and controlled using a single memory controller 300. Thus, the memory controller 300 may be configured to generate various control signals (e.g., command (CMD), address (ADDR) and/or data (DATA) signals) sufficient and compatible to control the access of data stored in the nonvolatile memory 230 and volatile memory 250.

As has been noted above, the memory controller 300 may be used to initialize the memory device 200 based on the boot code stored in the memory device 200. Assuming that the data storage capacity of the internal memory 310 of the memory controller is at least as large as the size of the boot code, all of the boot code may be loaded from the memory device 200 to the internal memory 310. And once all of the necessary boot code is loaded in the internal memory 310, the host 100 may initialize the memory device 200 by executing the boot code.

Then, once the memory device 200 is initialized, the memory controller 300 may load the fail information from the nonvolatile memory 230 to the internal memory 310. The memory controller 300 may load the fail information FI from the nonvolatile memory 230 using (or passing through) the volatile memory 250. Thereafter, the memory controller 300 may store write data received from the host 100 in the safe region 256 of the memory device 200 based on the fail information (FI).

In cases where both the boot code and fail information are read from the memory device 200, the fail information may be read after the reading of the boot code from the nonvolatile memory 230. Alternately, and depending on the data storage capacity of the internal memory 310, the fail information and the boot code may be simultaneously read from the nonvolatile memory 230. Alternately, the boot code may be read after the reading of the fail information from the nonvolatile memory 230.

Assuming that the data storage capacity of the internal memory 310 is less than the size of the boot code, all of the boot code cannot be loaded from the nonvolatile memory 230 to the internal memory 310. Therefore, some “residual boot code” not loaded in the internal memory 310 may instead be loaded to the safe region 256 and/or fail region 252 of the volatile memory 250. If the residual boot code is loaded in the safe region 256, it cannot be stored in such a manner that it then includes some material number of bit errors (i.e., is errant data). This is true because the memory controller 300 may not be allowed to execute (or fail to successfully execute) errant boot code. Thus, where possible the residual boot code will be stored in only the safe region 256 of the volatile memory 250.

However, the safe region of the volatile memory may not in certain cases be sufficiently large to accommodate the residual boot code. In cases where some portion of the residual boot code is loaded in the fail region 252 of the volatile memory 250, it is possible that a material number of bit errors may be introduced to the residual boot code. Left unaddressed, this result could provide errant boot code to the memory controller 300. Therefore, according to certain embodiments of the inventive concept, the host 100 and/or memory controller 300 may use the fail information to ensure that no portion of the residual boot code is loaded to the fail region 252 of the volatile memory 250. That is, the host 100 operating in conjunction with the memory controller 300 will only load residual boot code in the safe region 256 of the memory device 200 based on the fail information accurately identifying the fail region 252 in relation to the safe region 256.

In certain data processing schemes, a linked list may be used to load the fail information from the nonvolatile memory 230 to the volatile memory 250. It should be noted at this point that the safe region 256 of the volatile memory 250 may not be formed of only sequential addresses. For example, the safe region 256 may include a first safe sub-region and a second safe sub-region, where each one of the first and second safe sub-regions is a contiguous block of addresses, by the last address of the first safe sub-region is non-contiguous with the first address of the second safe sub-region. Under this assumption, a first portion of the fail information, as well as an address for the second safe sub-region will be stored in the first safe sub-region, and so forth for each successive safe sub-region in the safe region 256. The host 100 and/or memory controller 300 may successively obtain respective portions of the fail information from the first, second, third . . . Nth safe sub-regions using the linked list scheme.

The host 100 and/or memory controller 300 are configured to process data, including programming code such as boot data, stored in the internal memory 310 and/or the safe region 256 as designated by the fail information (S120).

In this regard, the host 100 and/or memory controller 300 may be used to map addresses based on the fail information so that critical programming code such as boot code will only be stored in the safe region 256 of the memory device 200. The host 100 and memory controller 300 may thus distinguish between the safe region 256 and fail region 252 of the volatile memory 250 using the fail information stored in the nonvolatile memory 230. For example, the host 100 and/or memory controller 300 may map logical addresses for write data provided by the host with “safe”, corresponding physical addresses for the safe region 256 using the fail information. That is, when critical programming code such as boot code, residual boot code, and/or fail information is being loaded from the nonvolatile memory 230 to the volatile memory 250 by the host 100 and/or memory controller 300, no logical addresses for the critical programming code will be mapped onto physical addresses residing in (or identified as being included in) the fail region 252.

By only storing critical programming code in the safe region 256 of the volatile memory 250, the memory system 10 of FIG. 2 prevents failed execution of such critical programming. That is, the potential for introducing additional data errors into the stored programming code is reduced over approaches that do not or cannot distinguish a fail region 252 from a safe region 256 of the volatile memory 250 using fail information stored in nonvolatile 230. In this regard, the fail information (FI) may be communicated from the memory controller 300 to the host 100 in certain embodiments of the inventive concept.

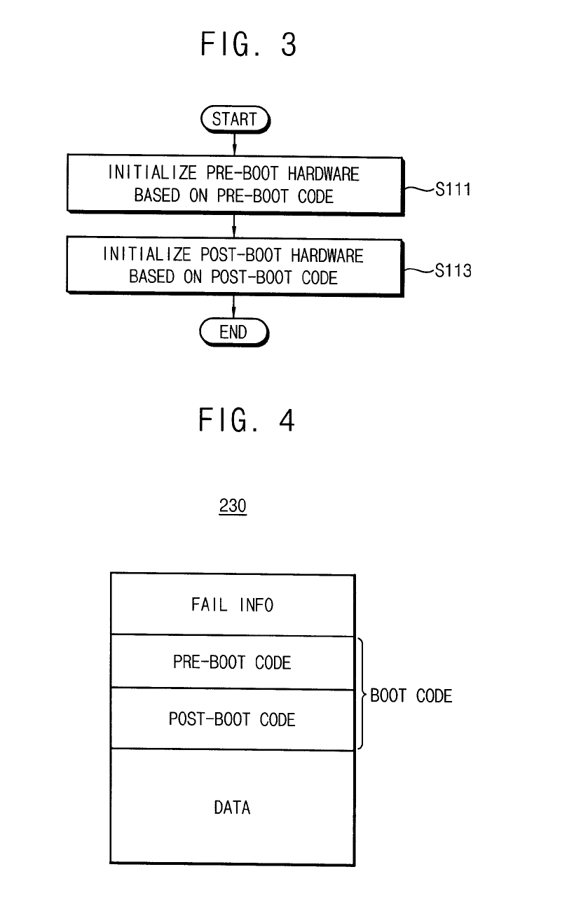

FIG. 3 is a flow chart illustrating in one example an approach to initializing hardware resources within the memory system operating method of FIG. 1. FIG. 4 is a conceptual diagram illustrating in one example an arrangement of stored boot code and fail information in the nonvolatile memory 230 of the memory system 10 of FIG. 2.

Referring to FIGS. 3 and 4, the step of initializing hardware resources (S110) described in relation to the flowchart of FIG. 1 may include; initializing certain “pre-boot hardware” resources (S111), and then initializing certain “post-boot hardware” resources (S113). In this context, pre-boot hardware is initialized by execution of “pre-boot code”—one portion of the stored boot code, and post-boot hardware is initialized by execution of “post-boot code”—another portion of the stored boot code. As shown in FIG. 4, the fail information (FAIL INFO), the all portions of the boot code (both pre-boot code and post-boot code) together with corresponding data (DATA) may be stored in designated sections of the nonvolatile memory 230.

In a case where the data storage capacity of the internal memory 310 is at least as great as the size of the pre-boot code, all of the pre-boot code may be loaded in the internal memory 310. Once the pre-boot code is loaded in the internal memory 310, the host 100 and/or memory controller 300 may initialize the pre-boot hardware resources based on the pre-boot code. Once the pre-boot hardware is initialized, the memory controller 300 may load the fail information from the nonvolatile memory 230 to the internal memory 310, or the memory controller 300 may load the fail information from the nonvolatile memory 230 to the volatile memory 250.

However, if the data storage capacity of the internal memory 310 is less than the size of the pre-boot code, a residual portion of the pre-boot code cannot be loaded in the internal memory 310 and may instead be loaded in the safe region 256 of the volatile memory 250. Therefore, the host 100 and/or memory controller 300 may use the fail information to ensure that the residual pre-boot code is not loaded in the fail region 252, but instead is only loaded in the safe region 256.

Following full execution of the pre-boot code, the host 100 and/or memory controller 300 may operate to initialize the post-boot hardware resources by executing the post-boot code stored in the memory device 200.

Here again, if the data storage capacity of the internal memory 310 is less than the size of the post-boot code, some residual post-boot code may be loaded in the safe region 256 instead of the internal memory 310. And consistent with the foregoing, this approach ensures that the post-boot code is loaded in only the safe region 256 of the volatile memory 250 based on the fail information, thereby avoiding the introduction (or reducing the possibility of introducing) additional data bit errors into the pre-boot and post-boot code.

FIG. 5 is a block diagram illustrating an electronic system including the memory system of FIG. 2.

Referring to FIG. 5, the electronic system 20 comprises in relevant part; the host 100, memory device 200, display device 201, storage device 202 and I/O device 203. It is assumed that certain pre-boot hardware (PRE_BH) is included in the memory device 200. When a power supply voltage is applied to the electronic system 20, the pre-boot hardware is first initialized-hardware. For example, in a mobile device including the memory system 10, as soon as the power supply voltage is applied to the mobile device, the memory device 200 will be among the first initialized hardware resources.

By way of comparison, certain post-boot hardware (POST_BH) is included in the display device 201, storage device 202 and/or I/O device 203. Here, post-boot hardware resources will be initialized only after the first initialized hardware resources (e.g., memory device 200) are initialized. For example, in the mobile device noted above, the later initialized hardware resources (e.g., the constituent display device 201, storage device 202 and/or I/O device 203) are only initialized once the memory device 200 is initialized.

FIG. 6 is a block diagram further illustrating in one example the initialization of certain pre-boot hardware resources using the initializing method of FIG. 3.

Referring to FIG. 6, the memory controller 300 is again assumed to include the internal memory 310, and the memory device 200 is assumed to include the nonvolatile memory 230 and volatile memory 250. Fail information (FAIL INFO), pre-boot code, post-boot code, and data (DATA) are stored in the nonvolatile memory 230. The volatile memory 250 again includes the safe region 256 and fail region 252.

The memory controller 300 begin an initialization routine by loading the pre-boot code required to initialize the first initialized hardware resources (PRE_BH) (e.g., the memory device 200) code from the memory device 200 to the internal memory 310. Once the pre-boot code is loaded in the internal memory 310, the host 100 and/or memory controller 300 may initialize the pre-boot hardware resources by executing the loaded pre-boot code. Once the pre-boot hardware resources are initialized, the memory controller 300 may load the fail information from the nonvolatile memory 230 to the internal memory 310.

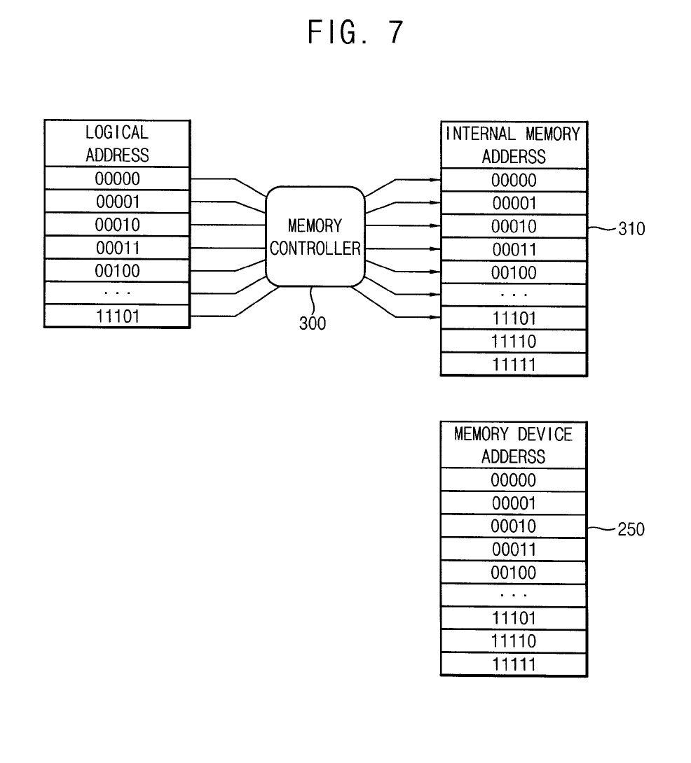

FIG. 7 is a conceptual diagram illustrating one example of address mapping that may be used in conjunction with the loading and execution of the pre-boot code described in FIG. 6.

Referring to FIG. 7, it is assumed that the host 100 accesses data stored in the memory device 200 according to a logical address, and the memory controller 300 maps the logical address provided by the host 100 to a corresponding address of the internal memory 310.

During the initializing of the pre-boot hardware resources, the pre-boot code is loaded from the nonvolatile memory 250 to the internal memory 310. Thus, the host 100 may access an address of the memory device 200 corresponding to the stored pre-boot code used to initialize the pre-boot hardware resources. However, under these conditions, if the physical address of the volatile memory 250 corresponding to the pre-boot code is somehow directly accessed, the initializing of the pre-boot hardware resources will not be performed, since the executable pre-boot code is stored in the internal memory 310. Therefore, in a case where the host 100 seeks to access an address of the memory device 200 corresponding to the pre-boot code, the memory controller 300 should “re-map” the address to an address for the of the internal memory 310.

For example, in a case where the host 100 accesses the address of the memory device 200 corresponding to 0000, the memory controller 300 may map the address of the memory device 200 corresponding to 0000 to the address of the internal memory 310 corresponding to 0000. In a case where the host 100 accesses the address of the memory device 200 corresponding to 0001, the memory controller 300 may map the address of the memory device 200 corresponding to 0001 to the address of the internal memory 310 corresponding to 0001. In a case where the host 100 accesses the address of the memory device 200 corresponding to 0010, the memory controller 300 may map the address of the memory device 200 corresponding to 0010 to the address of the internal memory 310 corresponding to 0010. In the same way, in a case where the host 100 accesses the address of the memory device 200 corresponding to 1111, the memory controller 300 may map the address of the memory device 200 corresponding to 1111 to the address of the internal memory 310 corresponding to 1111.

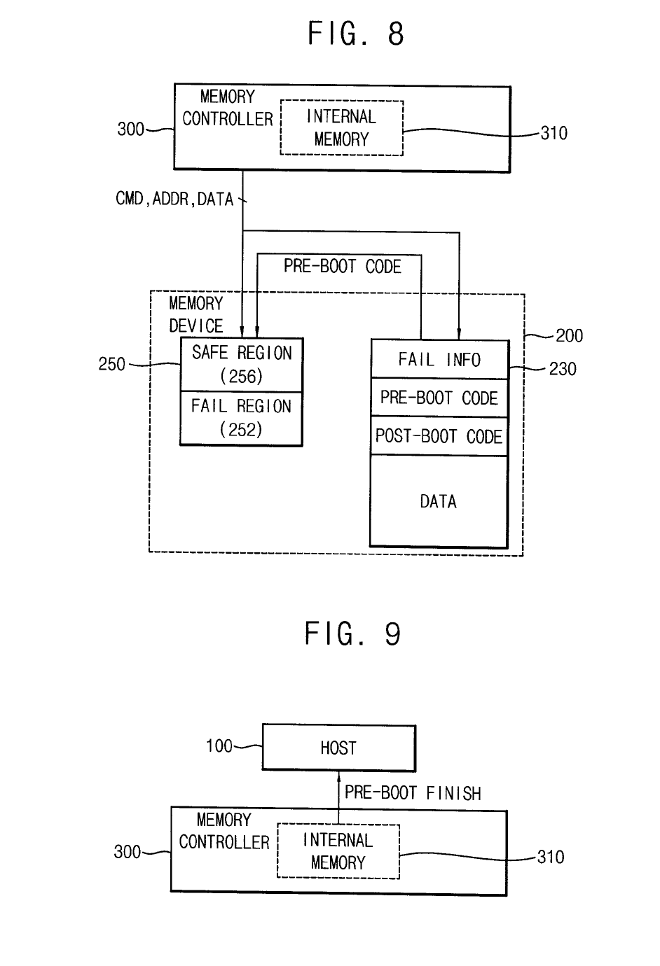

FIGS. 8, 9, 10, 11 and 14 are respective block diagrams illustrating a memory system similar to the memory systems of FIGS. 1 and 6.

FIG. 8 is a block diagram further describing in another example the initializing of pre-boot hardware using the method of FIG. 3.

Referring to FIG. 8, the memory controller 300 initializes certain pre-boot hardware by loading pre-boot code from the nonvolatile memory 230 to the volatile memory 250 based on the fail information.

If the data storage capacity of the internal memory 310 is less than the size of the pre-boot code, all of the pre-boot code cannot be loaded in the internal memory 310 at one time, and residual pre-boot code (not loaded in the internal memory 310) is instead loaded in the safe region 256 of the volatile memory 250 included in the memory device 200. That is, the host 100 and/or memory controller 300 may use the fail information to only load the pre-boot code to the safe region 255 in the memory device 200, as described above. Here again, a scheme using a linked list may be used recognizing that one or both of the safe region 256 and fail region 252 may comprises a number of non-contiguously addressed address blocks.

FIG. 9 is a block diagram illustrating the use of an end of initializing signal following the initializing of the pre-boot hardware of FIG. 6.

Referring to FIG. 9, after initializing the pre-boot hardware, the memory controller 300 may communicate a pre-boot end signal (PRE-BOOT FINISH) to the host 100. The pre-boot end signal definitively indicates the completion of the initialization for the pre-boot hardware resources. Then, the initializing of the post-boot hardware resources may be begun.

In relation to the illustrated example of FIG. 9, before the initializing of the pre-boot hardware resources, the memory controller 300 may be used to communicate a pre-boot read signal to the host 100 indicating that the memory controller 300 and/or memory device 200 are ready to begin initializing the pre-boot hardware resources.

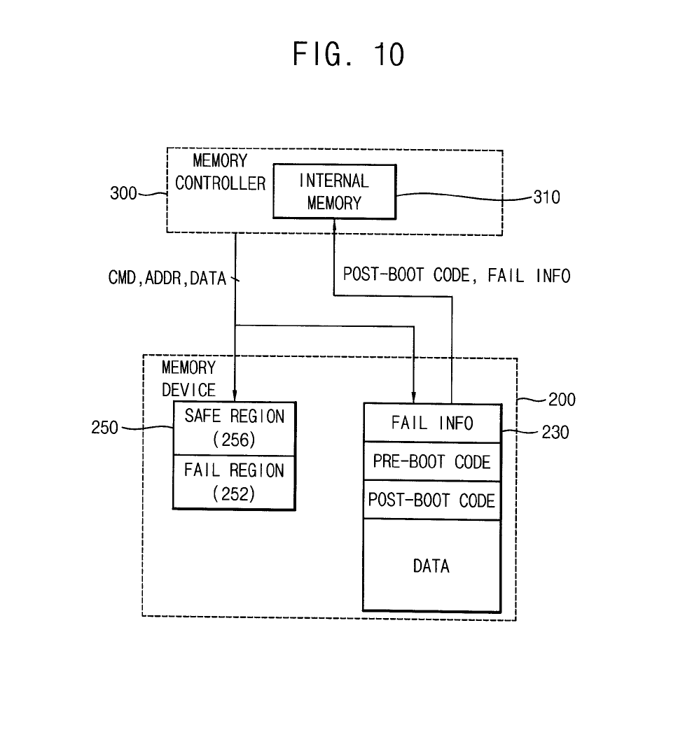

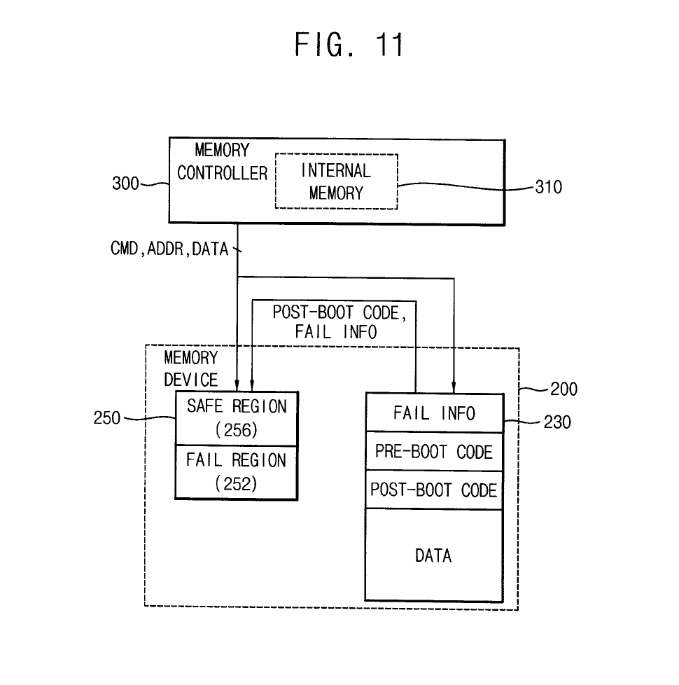

FIGS. 10 and 11 are respective block diagrams further describing examples of initializing certain post-boot hardware during the initializing method of FIG. 3.

Referring to FIGS. 10 and 11, the memory controller 300 may initialize the post-boot hardware resources by loading and executing the post-boot code in view of the fail information.

In a case where the data storage capacity of the internal memory 310 is at least as great as the size of the post-boot code, all of the post-boot code may be loaded in the internal memory 310. Once the post-boot code is loaded in the internal memory 310, the host 100 and/or memory controller 300 may initialize the post-boot hardware resources by executing the post-boot code. The memory controller 300 may also load the fail information from the nonvolatile memory 230 to the internal memory 310. The host 100 and/or memory controller 300 may cause programming code/data associated with the post-boot code (e.g., residual post-boot code not stored in the internal memory) to be stored only in the safe region 256 of the memory device 200 based on the fail information

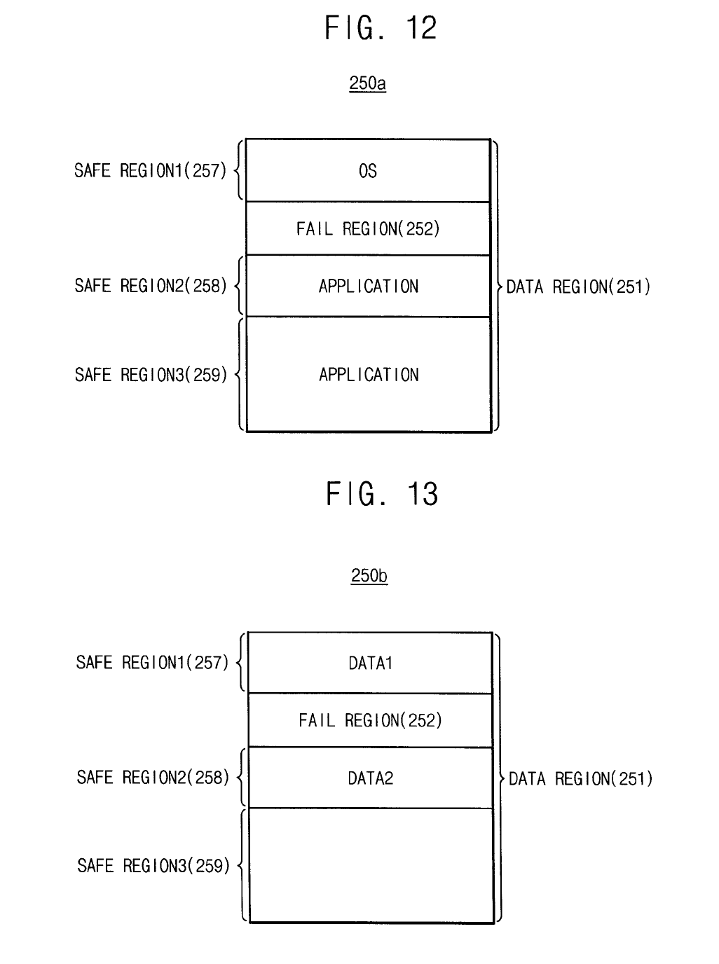

FIG. 12 is a conceptual diagram illustrating one use example (250a) for the volatile memory 250 of FIG. 2.

Referring to FIGS. 11 and 12, the volatile memory 250a includes a data region variously designated as the fail region 252 and safe region 256. After the initializing of the post-boot hardware resources following the initializing of the pre-boot hardware resource, the host 100 and/or memory controller 300 may cause programming code of an operating system (OS) to be loaded in the safe region 256 based on the fail information. Then, using the resources of the operating system, the host 100 and/or memory controller 300 may cause an application program (APPLICATION) to be loaded in the safe region 256 based on the fail information.

In FIG. 12, the safe region 256 includes a first safe sub-region (SAFE REGION 1) 257, a second safe sub-region (SAFE REGION 2) 258, and a third safe sub-region (SAFE REGION 3) 259. The operating system (OS) stored in the first safe sub-region 257 is assumed to have loaded the application program in both the second safe sub-region 258 and the third safe sub-region in view of the fail information FI.

FIG. 13 is a diagram illustrating another use example (250b) for the volatile memory 250 of FIG. 2.

Referring to FIGS. 11 and 13, the volatile memory 250b included in the memory system 10 includes the same data region described above in relation to FIG. 12. After the memory system 10 is initialized, the memory controller 300 may map logical addresses for data (DATA1, DATA2) provided by the host, for example, to corresponding physical addresses in the safe region 256 of the memory device 200. However, the memory controller 300 does not map the logical addresses onto corresponding physical address identified as being included in the fail region 252. Thus, a first block of the data (DATA1) is mapped to the first safe sub-region 257 of the safe region 256, and a second block of the data (DATA2) is mapped to the second safe sub-region 258 of the safe region 256. No data is mapped to the intervening fail region 252.

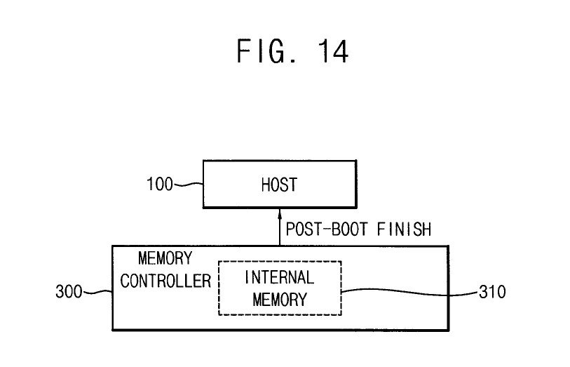

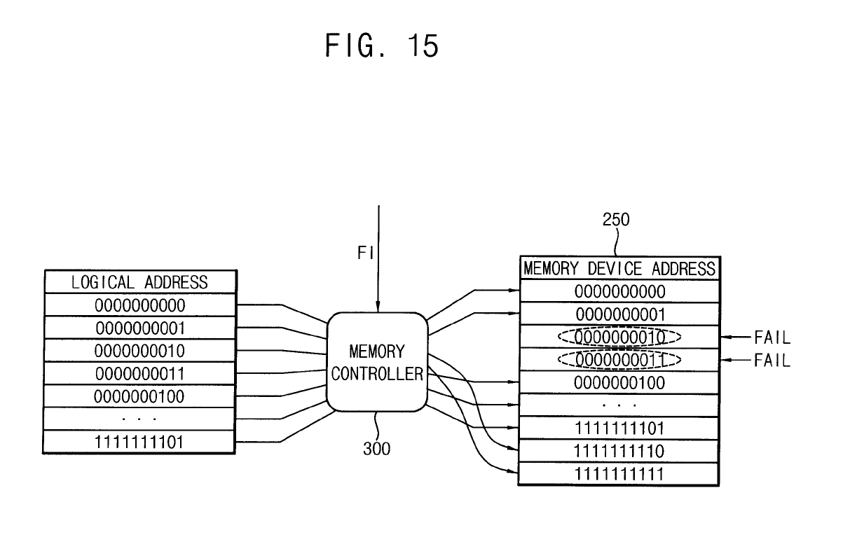

FIG. 14 is a block diagram further illustrating the use of an end of initializing signal following the initializing of the post-boot hardware resource in FIGS. 10 and 11.

Referring to FIG. 14, after the post-boot hardware resources have been successfully initialized, the memory controller 300 may communicate a post-boot end signal (POST-BOOT FINISH) to the host 100. The post-boot end signal indicates completion of the initialization of the post-boot hardware resources.

FIG. 15 is a conceptual diagram further illustrating in one example the mapping of logical addresses for write data, as communicated from the host 100, to corresponding physical addresses of the volatile memory 250 in the memory system of FIG. 2.

Referring to FIGS. 2 and 15 and consistent with the foregoing teachings, write data will be written by the host 100 and/or memory controller 300 to only the safe region 256 of the volatile memory 250 in accordance with stored fail information.

For example, the memory controller 300 will effectively block access to certain physical addresses of the memory device 200 (e.g., 0x0000000010 and 0x0000000011) associated with failed memory cells and designated as being in the fail region 252. In contrast, the memory controller 300 will grant access (i.e., allow mapping) to “safe” physical addresses of the memory device 200 (e.g., 0x0000000000, 0x0000000001, 0x0000000100, 0x0000000101, 0x0000000110 and 0x0000000111) and designated as being in the safe region 256.

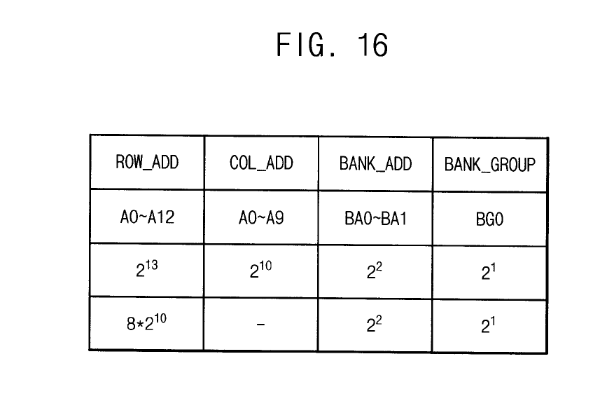

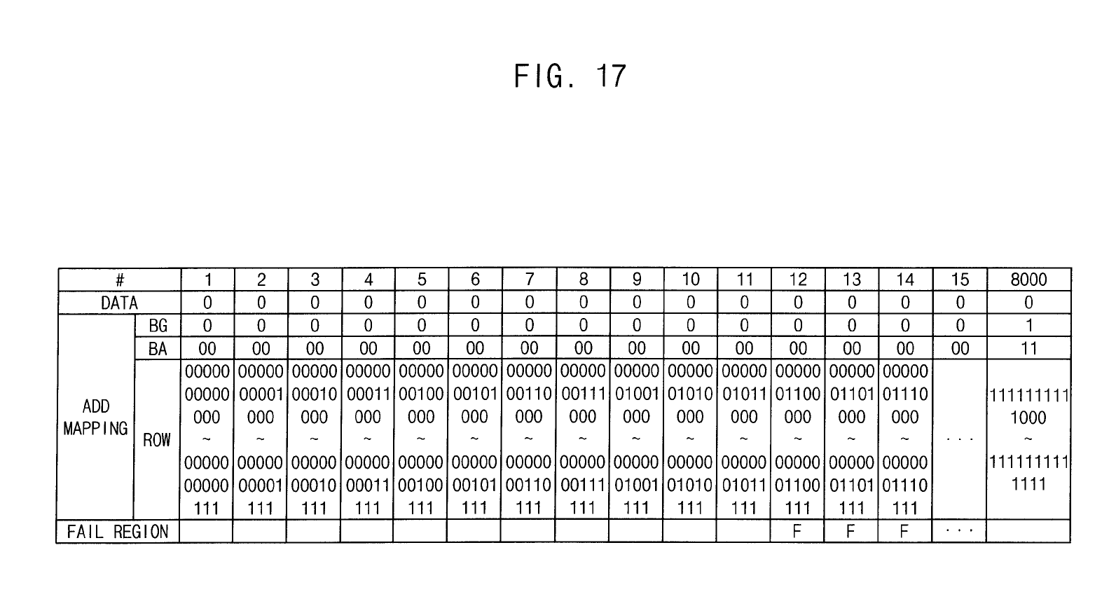

FIG. 16 is a table listing addresses assignments for memory cells of the memory device 200 included in the memory system of FIG. 2. FIG. 17 is an exemplary address mapping table for the memory system of FIG. 2.

Referring to FIGS. 16 and 17, the host 100 may be used to map logical addresses for write data to corresponding physical address in the safe region 256 based on one or more mapping table(s). Thus, the mapping table may be defined according to the fail information. In one example, the mapping table is formed by grouping row addresses and/or column addresses for the memory device 200.

Thus, a number of bits assigned to the row address ROW_ADD included in the memory device 200 may be 13 bits. A number of bits assigned to the column address COL_ADD included in the memory device 200 may be 10 bits. A number of bits assigned to the bank address BANK_ADD included in the memory device 200 may be 2 bits. A number of bits assigned to the bank group address BANK_GROUP included in the memory device 200 may be 1 bit. The address mapping table 130 may be generated by composing a mapping unit for 8 row addresses. In this case, the total number of the mapping units will be (2̂10*2̂2*2) or 8000.

An address mapping may be determined according to the fail information and the mapping table. Thus, the host 100 and/or memory controller 300 may stop loading program code and/or data in addresses designated as being in the fail region 252 of the memory device 200 by the fail information. For example, the row addresses in the memory device 200 may be from 0x0000000000000 to 0x1111111111111. The value of the fail information cell unit corresponding to the address 0x0000001100000˜0x0000001100111 may be 1. The value of the fail information cell unit corresponding to the address 0x0000001101000˜0x0000001101111 may be 1. The value of the fail information cell unit corresponding to the address 0x0000001110000˜0x0000001110111 may be 1.

If the value of the fail information cell unit is 1, the unit fail information UFI may be bad and if the value of the fail information cell unit is 0, the unit fail information UFI may be good. In other words, the ‘1’ of the unit fail information indicates that a corresponding portion of the memory device 200 is bad. The ‘0’ of the unit fail information indicates that the corresponding portion of the memory device 200 is good. Therefore the cells included in the memory device 200 corresponding to the row addresses 0x0000001100000˜0x0000001100111, 0x0000001101000˜0x0000001101111 and 0x0000001110000˜0x0000001110111 may be the bad cells. A region included in the memory device 200 corresponding to the row addresses 0x0000001100000˜0x0000001100111, 0x0000001101000˜0x0000001101111 and 0x0000001110000˜0x0000001110111 may be included in the fail region 252. Also, the cells included in the memory device 200 corresponding to the row addresses except for the row addresses 0x0000001100000˜0x0000001100111, 0x0000001101000˜0x0000001101111 and 0x0000001110000˜0x0000001110111 may be the good cells. A region included in the memory device 200 corresponding to the row addresses except for the row addresses 0x0000001100000˜0x0000001100111, 0x0000001101000˜0x0000001101111 and 0x0000001110000˜0x0000001110111 may be included in the safe region 256.

If the memory controller 300 writes data to and reads data from the safe region 256 of the memory device 200, bit errors will not be generated. However, if the memory controller 300 writes data to and reads data from the fail region 252 of the memory device 200, bit errors may be generated. Accordingly, the memory controller 300 will stop allowing access to the physical address corresponding to the fail region 252 using the fail information.

For example, because the cells included in the memory device 200 corresponding to the row addresses 0x0000001100000˜0x0000001100111, 0x0000001101000˜0x0000001101111 and 0x0000001110000˜0x0000001110111 are the bad cells, the memory controller 300 may stop accessing the physical addresses 0x0000001100000˜0x0000001100111, 0x0000001101000˜0x0000001101111 and 0x0000001110000˜0x0000001110111. Because the cells included in the memory device 200 corresponding to the row addresses except for the row addresses 0x0000001100000˜0x0000001100111, 0x0000001101000˜0x0000001101111 and 0x0000001110000˜0x0000001110111 are the good cells, the memory controller 300 may access the physical addresses except for the row addresses 0x0000001100000˜0x0000001100111, 0x0000001101000˜0x0000001101111 and 0x0000001110000˜0x0000001110111.

In the foregoing case, the fail information is the information regarding the addresses of failed memory cells designated in the fail region 252 of the memory device 200. The memory controller 300 may read the fail information stored in the memory device 200 using the same set of control signals (e.g., command CMD and address ADDR).

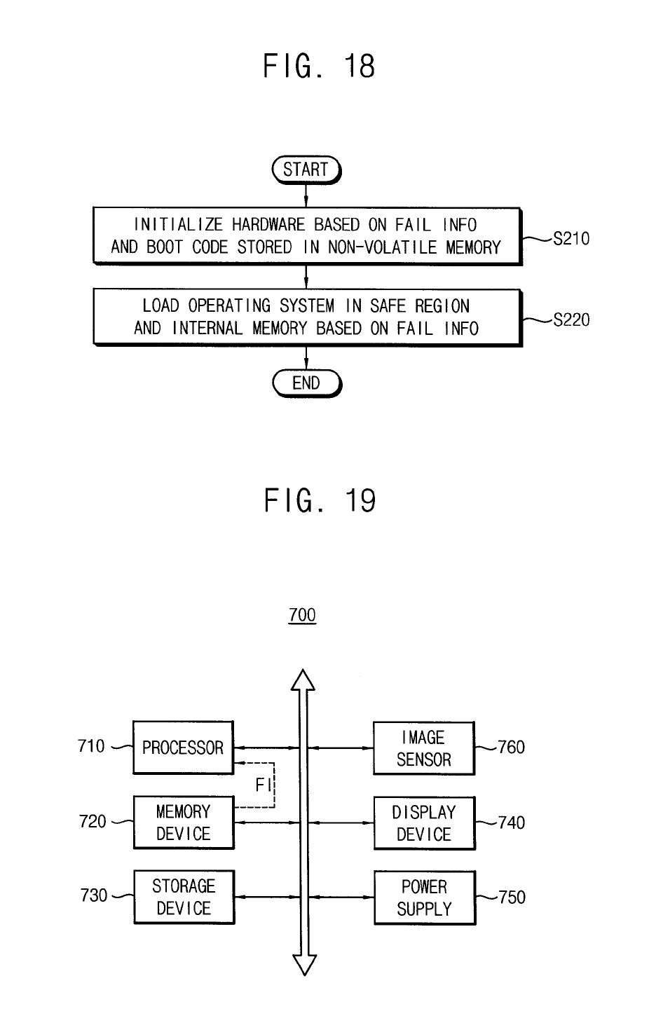

FIG. 18 is a flow chart summarizing in another example a method of initializing a memory system according to embodiments of the inventive concept.

Referring to FIGS. 2 and 18, certain hardware resources are initialized in response to application of a power supply voltage based on fail information and boot code stored in the nonvolatile memory 230 of the memory device 200 (S210) under the control of the host 100 and/or the memory controller 300. Then, consistent with the foregoing embodiments, the host 100 and/or memory controller may be used to load an operating system (OS) in an internal memory 310 of the memory controller 300 and/or the safe region 256 of the memory device 200 based on the fail information (S220).

FIG. 19 is a block diagram illustrating a mobile device including the memory system according to an embodiment of the inventive concept.

Referring to FIG. 19, a mobile device 700 comprises; a processor 710, a memory device 720, a storage device 730, a display device 740, a power supply 750 and an image sensor 760. The mobile device 700 may further include ports that communicate with a video card, a sound card, a memory card, a USB device, other electronic devices, etc.

The processor 710 may perform various calculations or tasks. According to embodiments, the processor 710 may be a microprocessor or a CPU. The processor 710 may communicate with the memory device 720, the storage device 730, and the display device 740 via an address bus, a control bus, and/or a data bus. In some embodiments, the processor 710 may be coupled to an extended bus, such as a peripheral component interconnection (PCI) bus. The memory device 720 may store data for operating the mobile device 700. For example, the memory device 720 may be implemented with a dynamic random access memory (DRAM) device, a mobile DRAM device, a static random access memory (SRAM) device, a phase-change random access memory (PRAM) device, a ferroelectric random access memory (FRAM) device, a resistive random access memory (RRAM) device, and/or a magnetic random access memory (MRAM) device. The memory device 720 includes the data loading circuit according to example embodiments. The storage device 730 may include a solid state drive (SSD), a hard disk drive (HDD), a CD-ROM, etc. The mobile device 700 may further include an input device such as a touchscreen, a keyboard, a keypad, a mouse, etc., and an output device such as a printer, a display device, etc. The power supply 750 supplies operation voltages for the mobile device 700.

The image sensor 760 may communicate with the processor 710 via the buses or other communication links. The image sensor 760 may be integrated with the processor 710 in one chip, or the image sensor 760 and the processor 710 may be implemented as separate chips.

At least a portion of the mobile device 700 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP). The mobile device 700 may be a digital camera, a mobile phone, a smart phone, a portable multimedia player (PMP), a personal digital assistant (PDA), a computer, etc.

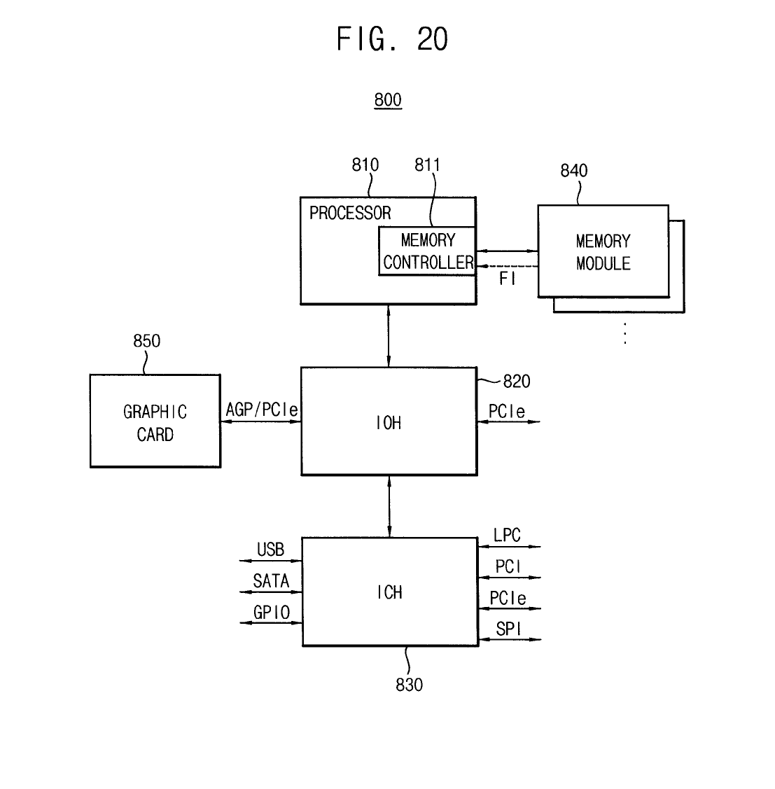

FIG. 20 is a block diagram illustrating a computing system including one or more memory system(s) according to certain embodiments of the inventive concept.

Referring to FIG. 20, a computing system 800 comprises; a processor 810, a I/O hub (IOH) 820, an I/O controller hub (ICH) 830, at least one memory module 840 and a graphics card 850. In some embodiments, the computing system 800 may be a personal computer (PC), a server computer, a workstation, a laptop computer, a mobile phone, a smart phone, a personal digital assistant (PDA), a portable multimedia player (PMP), a digital camera), a digital television, a set-top box, a music player, a portable game console, a navigation system, etc.

The processor 810 may perform various computing functions, such as executing specific software for performing specific calculations or tasks. For example, the processor 810 may be a microprocessor, a central process unit (CPU), a digital signal processor, or the like. In some embodiments, the processor 810 may include a single core or multiple cores. For example, the processor 810 may be a multi-core processor, such as a dual-core processor, a quad-core processor, a hexa-core processor, etc. In some embodiments, the computing system 800 may include a plurality of processors. The processor 810 may include an internal or external cache memory.

The processor 810 may include a memory controller 811 for controlling operations of the memory module 840. The memory controller 811 included in the processor 810 may be referred to as an integrated memory controller (IMC). A memory interface between the memory controller 811 and the memory module 840 may be implemented with a single channel including a plurality of signal lines, or may bay be implemented with multiple channels, to each of which at least one memory module 840 may be coupled. In some embodiments, the memory controller 811 may be located inside the input/output hub 820, which may be referred to as memory controller hub (MCH).

The input/output hub 820 may manage data transfer between processor 810 and devices, such as the graphics card 850. The I/O hub 820 may be coupled to the processor 810 via various interfaces. For example, the interface between the processor 810 and the input/output hub 820 may be a front side bus (FSB), a system bus, a HyperTransport, a lightning data transport (LDT), a QuickPath interconnect (QPI), a common system interface (CSI), etc. In some embodiments, the computing system 800 may include a plurality of I/O hubs. The I/O hub 820 may provide various interfaces with the devices. For example, the I/O hub 820 may provide an accelerated graphics port (AGP) interface, a peripheral component interface-express (PCIe), a communications streaming architecture (CSA) interface, etc.

The graphics card 850 may be coupled to the I/O hub 820 via AGP or PCIe. The graphics card 850 may control a display device (not shown) for displaying an image. The graphics card 850 may include an internal processor for processing image data and an internal memory device. In some embodiments, the input/output hub 820 may include an internal graphics device along with or instead of the graphics card 850 outside the graphics card 850. The graphics device included in the input/output hub 820 may be referred to as integrated graphics. Further, the input/output hub 820 including the internal memory controller and the internal graphics device may be referred to as a graphics and memory controller hub (GMCH).

The I/O controller hub 830 may perform data buffering and interface arbitration to efficiently operate various system interfaces. The I/O controller hub 830 may be coupled to the input/output hub 820 via an internal bus, such as a direct media interface (DMI), a hub interface, an enterprise Southbridge interface (ESI), PCIe, etc. The I/O controller hub 830 may provide various interfaces with peripheral devices. For example, the I/O controller hub 830 may provide a universal serial bus (USB) port, a serial advanced technology attachment (SATA) port, a general purpose input/output (GPIO), a low pin count (LPC) bus, a serial peripheral interface (SPI), PCI, PCIe, etc.

In some embodiments, the processor 810, the I/O hub 820 and the I/O controller hub 830 may be implemented as separate chipsets or separate integrated circuits. In other embodiments, at least two of the processor 810, the I/O hub 820 and the I/O controller hub 830 may be implemented as a single chipset.

Various embodiments of the inventive concept may be applied to systems such as be a mobile phone, a smart phone, a personal digital assistant (PDA), a portable multimedia player (PMP), a digital camera, a music player, a portable game console, a navigation system, etc. The foregoing is illustrative of exemplary embodiments and is not to be construed as limiting thereof. Although a few embodiments have been described, those skilled in the art will readily appreciate that many modifications are possible in the illustrated embodiments without materially departing from the scope of the inventive concept as defined in the following claims.

What is claimed is:

1. A method of operating a memory system including a host, a memory controller including an internal memory, and a memory device, wherein the memory device includes a nonvolatile memory and a volatile memory having a safe region and a fail region, the method comprising:
initializing hardware resources based on fail information and boot code stored in the nonvolatile memory; and thereafter,
storing write data provided by the host in only the safe region of the memory device, wherein the fail information is used by the memory controller to differentiate between the fail region and safe region of the memory device.

2. The method of claim 1, wherein the initializing of the hardware resources comprises:
loading the boot code from the nonvolatile memory to the internal memory;
using the memory controller to execute the loaded boot code to initialize the hardware resources; and
loading the fail information from the nonvolatile memory to the internal memory.

3. The method of claim 1, wherein the fail information is loaded from the nonvolatile memory to the internal memory only after the memory device is initialized as part of the initialization of the hardware resources.

4. The method of claim 1, wherein the boot code includes pre-boot code and post-boot code, and the initializing of the hardware resources comprises:
initializing pre-boot hardware among the hardware resources by executing the pre-boot code; and thereafter,
initializing post-boot hardware among the hardware resources different from the pre-boot hardware resources by executing the post-boot code.

5. The method of claim 4, wherein the pre-boot hardware includes the memory device, and the post-boot hardware includes at least one of a display device, a storage device and an input-output device.

6. The method of claim 5, further comprising:
before executing the pre-boot code, loading the pre-boot code from the nonvolatile memory to the internal memory; and
after initializing the pre-boot hardware and before executing the post-boot code, loading the post-boot code from the nonvolatile memory to the internal memory.

7. The method of claim 6, wherein only after initializing the pre-boot hardware, loading the fail information from the nonvolatile memory to the internal memory.

8. The method of claim 1, wherein the storing of the write data provided by the host in only the safe region of the memory device comprises:
using the memory controller to map a logical address provided with the write data by the host to a corresponding physical address of the safe region of the memory device using the fail information.

9. The method of claim 4, further comprising:
after initializing the pre-boot hardware, the memory controller communicates a pre-boot end signal to the host.

10. The method of claim 9, further comprising:
after initializing the post-boot hardware, the memory controller communicates a post-boot end signal to the host.

11. The method of claim 10, further comprising:
after initializing the post-boot hardware, the memory controller loads an operating system to the safe region based on the fail information.

12. A method of operating a memory system including a host, a memory controller including an internal memory, and a memory device, wherein the memory device includes a nonvolatile memory and a volatile memory having a safe region and a fail region, the method comprising:
loading a portion of boot code stored from the nonvolatile memory to the internal memory, wherein a data storage capacity of the internal memory is less than a size of the boot code;
loading residual boot code from the nonvolatile memory to only the safe region of the volatile memory, wherein the fail information is used by the memory controller to differentiate between the fail region and safe region of the memory device during the storing of the residual boot code; and
initializing hardware resources by executing the boot code using at least one of the host and the memory controller.

13. The method of claim 12, wherein the fail information is loaded from the nonvolatile memory to one of the internal memory and the safe region only after the memory device is initialized as part of the initialization of the hardware resources.

14. The method of claim 12, wherein the boot code includes pre-boot code and post-boot code, and the initializing of the hardware resources comprises:
initializing pre-boot hardware among the hardware resources by executing the pre-boot code; and thereafter,
initializing post-boot hardware among the hardware resources different from the pre-boot hardware resources by executing the post-boot code.

15. The method of claim 14, wherein the pre-boot hardware includes the memory device, and the post-boot hardware includes at least one of a display device, a storage device and an input-output device.

16. The method of claim 15, further comprising:
before executing the pre-boot code, loading the pre-boot code from the nonvolatile memory to one of the internal memory and the safe region; and
after initializing the pre-boot hardware and before executing the post-boot code, loading the post-boot code from the nonvolatile memory to one of the internal memory and the safe region.

17. The method of claim 16, wherein only after initializing the pre-boot hardware, loading the fail information from the nonvolatile memory to one of the internal memory and the safe region.

18. The method of claim 12, further comprising:
storing write data provided by the host in only the safe region of the memory device using the memory controller to map a logical address provided with the write data by the host to a corresponding physical address of the safe region of the memory device using the fail information.

19. The method of claim 14, further comprising:
after initializing the pre-boot hardware, the memory controller communicates a pre-boot end signal to the host; and
after initializing the post-boot hardware, the memory controller communicates a post-boot end signal to the host.

20. A method of operating a memory system including a host, a memory controller including an internal memory, and a memory device, wherein the memory device includes a nonvolatile memory and a volatile memory having a safe region and a fail region, the method comprising:
storing fail information in the nonvolatile memory that identifies addresses corresponding to failed memory cells in a memory cell array of the volatile memory;
designating the fail region from the safe region of the volatile memory using the fail information;
upon receiving a power supply voltage, loading boot code stored in the nonvolatile memory to one of the internal memory and the safe region; and
initializing hardware resources by executing the boot code using at least one of the host and the memory controller.
